(19) United States
(12) Patent Application Publication
(10) Pub. No.: US 2026/0094015 A1
(43) Pub. Date: Apr. 2, 2026

(54) DYNAMIC PROMPT CREATION FOR ENHANCED GENERATIVE AI INTERACTIONS

(71) Applicant: Kyndryl, Inc., New York, NY (US)

(72) Inventors: Mouleswara Reddy Chintakunta, Allagadda (IN); Anil Babu Boppanna, Bangalore (IN); Omar Odibat, Cedar Park, TX (US); Li Long Chen, Beijing (CN)

(21) Appl. No.: 18/904,369

(22) Filed: Oct. 2, 2024

(51) Int. Cl. G06N 5/022

(52) U.S. Cl. CPC G06N 5/022

(57) ABSTRACT

Embodiments relate to providing event-driven dynamic prompt creation for enhanced generative artificial intelligence (AI) interactions. An aspect includes receiving a plurality of user data characterizing user behavior associated with an electronic device. An aspect includes generating a dynamic prompt based in part on a portion of the plurality of user data, inputting the dynamic prompt to an AI model to generate a response, and causing the response of the AI model to be presented on the electronic device.

### BACKGROUND

The present invention generally relates to computer systems, and more specifically, to computer-implemented methods, computer systems, and computer program products configured and arranged to provide event-driven dynamic prompt creation for enhanced generative artificial intelligence (AI) interactions.

AI is in the field of computer science relating to the development of computer systems for performing tasks that typically require human intelligence, such as speech recognition, natural language processing (NLP), text generation and translation, video, sound, and image generation, decision making, planning, and more. In general, AI refers to the development of intelligent systems that can mimic human behavior and decision-making processes. AI encompasses techniques and approaches enabling machines to perform tasks, analyze visual and textual data, and respond or adapt to their environment. One of the advantages of artificial intelligence is its ability to process large amounts of data and find patterns in it. As such, AI tools are designed to make decisions or take actions based on that knowledge.

### SUMMARY

Embodiments of the present invention are directed to computer-implemented methods for event-driven dynamic prompt creation for enhanced generative artificial intelligence (AI) interactions. A non-limiting computer-implemented method includes receiving a plurality of user data characterizing user behavior associated with an electronic device, and generating a dynamic prompt based in part on a portion of the plurality of user data. The method includes inputting the dynamic prompt to an AI model to generate a response and causing the response of the AI model to be presented on the electronic device.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system configured to dynamically provide event-driven dynamic prompt creation for enhanced generative artificial intelligence (AI) interactions according to one or more embodiments of the present invention;

FIG. 3 is a flowchart of a computer-implemented method for dynamically providing event-driven dynamic prompt creation for enhanced generative AI interactions according to one or more embodiments of the present invention;

FIG. 4 is a flowchart of a computer-implemented method for capturing user behavior according to one or more embodiments of the present invention;

FIG. 5 is a flowchart of a computer-implemented method for storing and processing user behavior of a user according to one or more embodiments of the present invention;

FIG. 6 is a flowchart of a computer-implemented method for dynamic prompt creation according to one or more embodiments of the present invention;

FIG. 7 is a flowchart of a computer-implemented method for knowledge graph pruning according to one or more embodiments of the present invention;

FIG. 8 is a flowchart of a computer-implemented method for providing event-driven dynamic prompt creation for enhanced generative AI interactions such that the dynamic prompt is utilized as input to generative AI models on behalf of a user according to one or more embodiments of the present invention;

FIG. 9 depicts a cloud computing environment according to one or more embodiments of the present invention; and

FIG. 10 depicts abstraction model layers according to one or more embodiments of the present invention.

### DETAILED DESCRIPTION

One or more embodiments are configured and arranged to provide event-driven dynamic prompt creation for enhanced generative artificial intelligence (AI) interactions. One or more embodiments dynamically generate prompts for generative AI engines based on user behavior and events captured in a knowledge graph. This system continuously updates and personalizes prompts according to real-time user interactions and the evolving relationships within the knowledge graph. By integrating these dynamic, context-aware inputs, the system ensures that AI-generated responses are both relevant and personalized, substantially improving the effectiveness of AI applications in delivering accurate and timely recommendations/information across various domains. By utilizing event-driven insights for real-time tailoring and by dynamically adapting prompts to the changing user behavior, one or more embodiments enhance response accuracy with personalization for the user.

In generative AI applications, the prevalent use of static prompts may present several challenges. These static prompts are preset and fail to adapt to changes in user behavior or data, leading to several specific drawbacks including lack of adaptability, scalability issues, inadequate personalization, and decreases in relevance. Regarding lack of adaptability, despite a user repeatedly providing negative feedback (e.g., thumbs down) to hosting systems, a typical system continues to recommend the same services. This indicates a failure to adapt to user feedback and preferences. With respect to scalability issues, the volume of user interactions and events, coupled with continually updating an array of services and tools, poses scalability challenges for static systems. Regarding inadequate personalization, static prompts cannot modify their outputs to reflect real-time changes in user preferences, often leading to suggestions that do not align with the user’s current needs. With respect to decreased relevance, as the interest of the user shifts, static prompts do not update, often resulting in responses that are outdated or irrelevant.

One or more embodiments provide a method and system that dynamically adjust to user behavior and evolving data relationships. The system generates dynamic prompts based on a continuous analysis of user interactions and knowledge graph insights, which improve the personalization and relevance of AI responses, thereby enhancing user satisfaction and the overall efficiency of AI systems.

Generative AI engines use generative artificial intelligence which is a type of AI that can create new content and ideas, including conversations, stories, images, videos, and music. AI technologies attempt to mimic human intelligence in nontraditional computing tasks like image recognition, natural language processing (NLP), and translation. Generative AI is trained to learn human language, programming languages, art, chemistry, biology, or any complex subject matter. Generative AI reuses training data to solve new problems. For example, it can learn the English vocabulary and create a poem from the words it processes. An organization can use generative AI for various purposes. Like all artificial intelligence, generative AI works by using machine learning models such as very large models that are pretrained on vast amounts of data. Examples of very large models can include foundation models and large language models.

Foundation models: Foundation models (FMs) are machine learning models trained on a broad spectrum of generalized and unlabeled data. Foundation models are capable of performing a wide variety of general tasks. Foundation models are the result of the latest advancements in a technology that has been evolving for decades. In general, a foundational model uses learned patterns and relationships to predict the next item in a sequence. For example, with image generation, the foundational model analyzes the image and creates a sharper, more clearly defined version of the image. Similarly, with text, the foundational model predicts the next word in a string of text based on the previous words and their context. The foundational model then selects the next word using probability distribution techniques.

Large language models: Large language models (LLMs) are one class of foundational models. LLMs are specifically focused on language-based tasks such as summarization, text generation, classification, open-ended conversation, and information extraction.

One or more embodiments described herein can utilize machine learning techniques to perform tasks, such as classifying a feature of interest. More specifically, one or more embodiments described herein can incorporate and utilize role-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by neural networks in nature. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

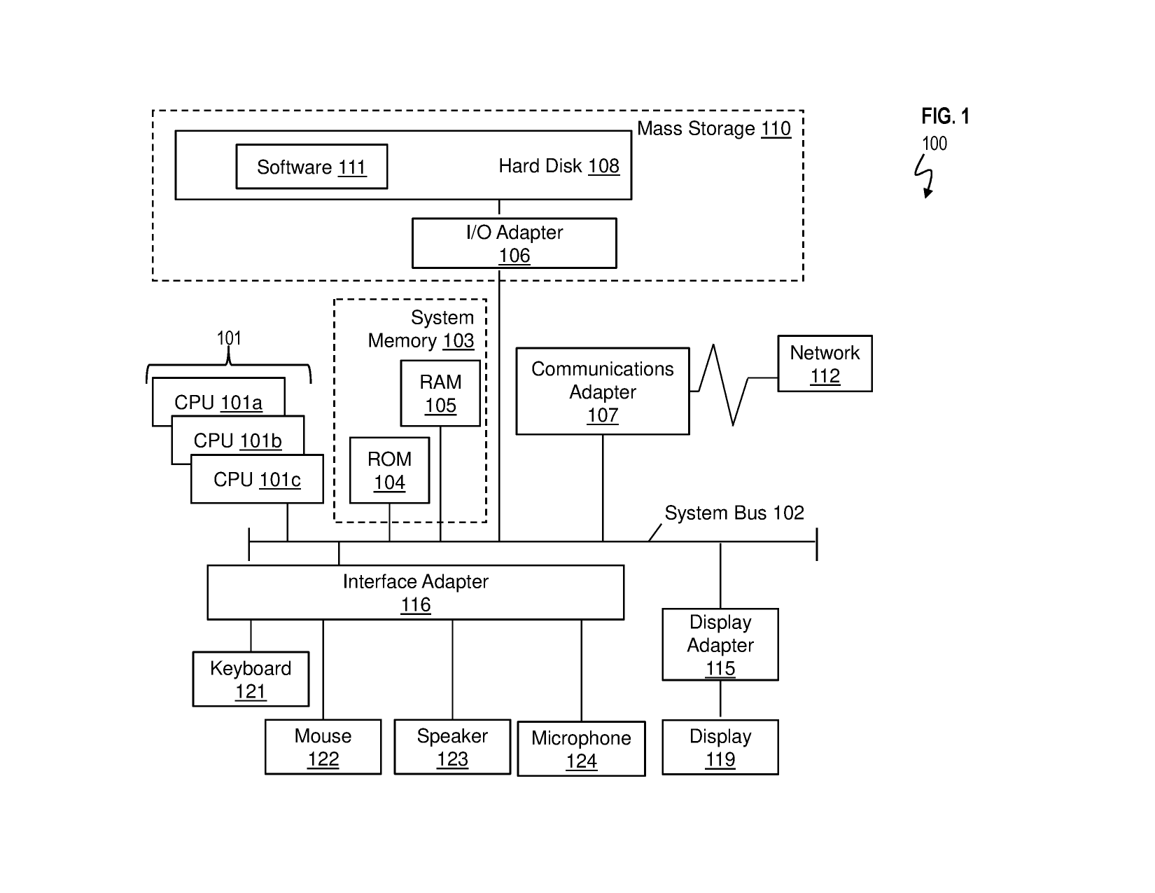

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction are discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

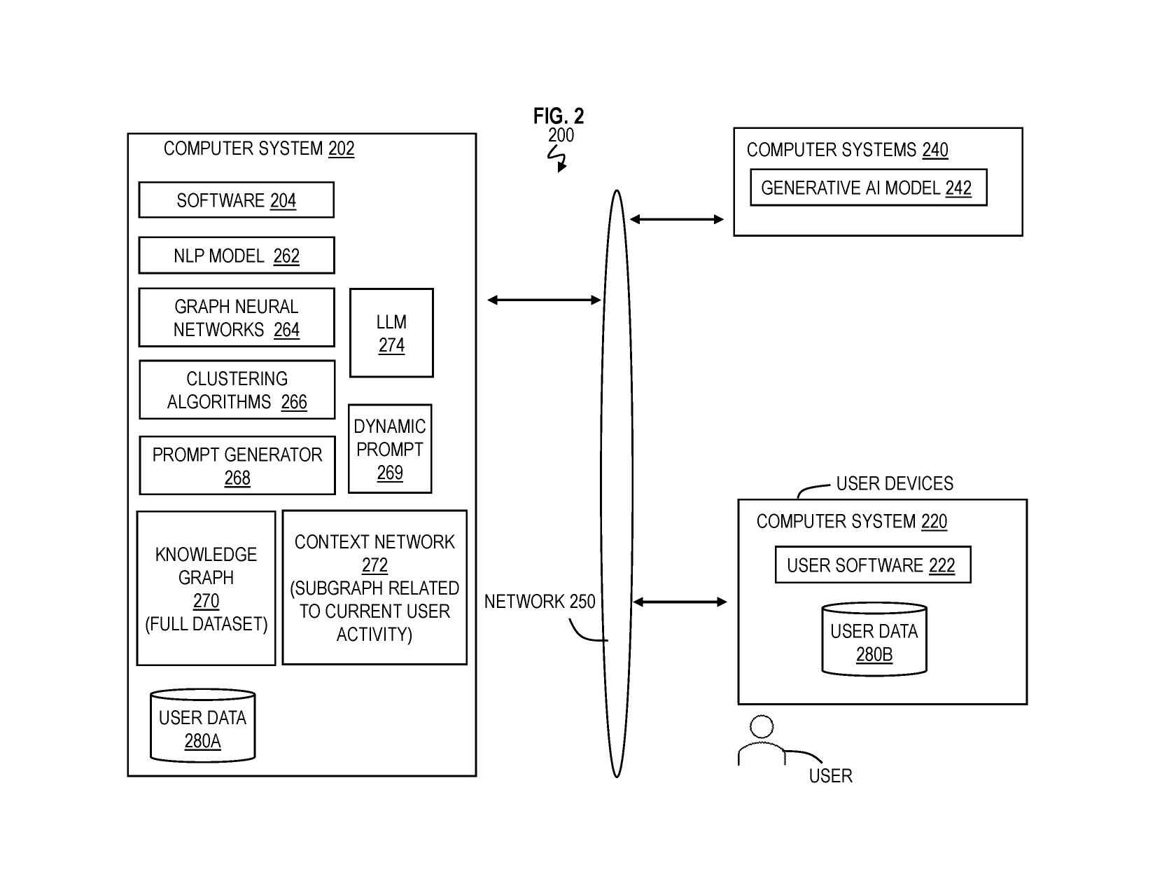

Now turning to FIG. 2, a block diagram depicts an example system 200 configured to provide event-driven dynamic prompt creation for enhanced generative AI interactions such that the dynamic prompt is utilized as input to one or more generative AI models on behalf of a user in order to receive responses according to one or more embodiments.

LLMs, on which generative AI engines are built, have powerful capabilities, and prompt engineering helps to discover capabilities, improve reliability, reduce failure cases, and save on computing resources when utilizing LLMs, in accordance with one or more embodiments. Moreover, prompt engineering is a technique for developing and optimizing prompts to efficiently use language models for a wide variety of applications and research topics.

The system 200 includes a computer system 202 configured to communicate over a network 250 with many different computer systems, such as computer systems 240 and computer systems 220. The computer system 240 can host one or more generative AI models 242 commonly known by one of ordinary skill in the art. The computer system 240 can be representative of numerous computer systems hosting various generative AI models 242.

The network 250 can be a wired and/or wireless communication network, and the communication network includes a telecommunications network, the public switched telephone network (PTSN), voice over IP (VOIP) network, etc. The communication network includes cellular networks, satellite networks, etc.

As represented by computer system 220, the user devices can be a personal computer or laptop. The user device may be a holographic device. The user devices can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The computer system 220 can include various software and hardware components including software applications (apps) for communicating over the network 250 as understood by one of ordinary skill in the art. The software applications provide users with a way to access information, services, entertainment, etc. The computer systems 220 can include various software and hardware components designed to perform specific functions as discussed herein including user software 222. In one or more embodiments, the computer system 220 can communicate with the computer system 202 in order to cause the computer system 202 to assist with execution of one or more tasks, for example, in a client server relationship.

The computer system 202, computer systems 220 (e.g., user devices), user software 222, software 204, NLP model 262, graph neural networks 264, clustering algorithms 266, prompt generator 268, etc., can include functionality and features of the computer system 100 in FIG. 1 including various hardware components and various software applications such as software 111 which can be executed as instructions on one or more processors 101 in order to perform actions according to one or more embodiments of the invention. The software 204 and user software 222 can include, be integrated with, and/or call other pieces of software, algorithms, application programming interfaces (APIs), graphical user interfaces (GUIs) etc., to operate as discussed herein.

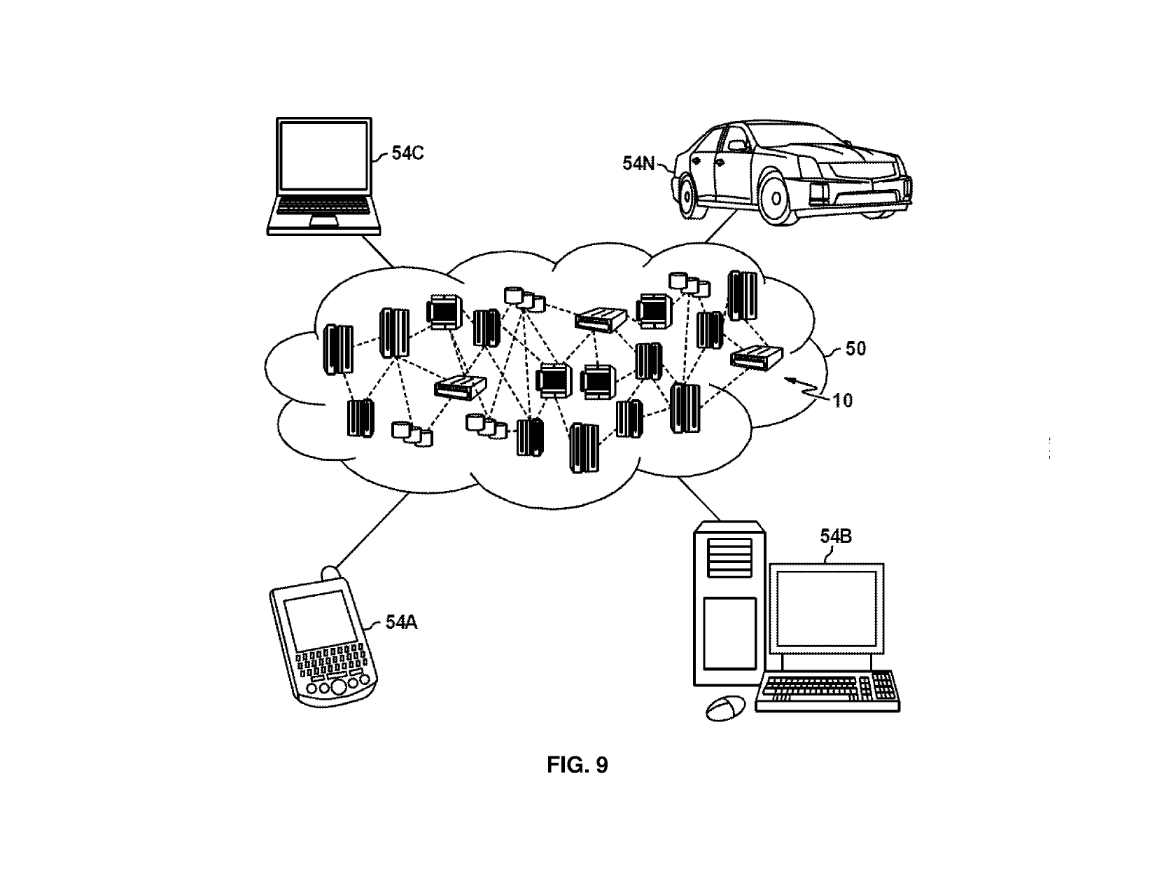

The computer system 202 may be representative of numerous computer systems and/or distributed computer systems configured to provide event-driven dynamic prompt creation for enhanced generative AI interactions to users of the computer systems 220. The computer system 202 can be part of a cloud computing environment such as a cloud computing environment 50 depicted in FIG. 9, as discussed further herein.

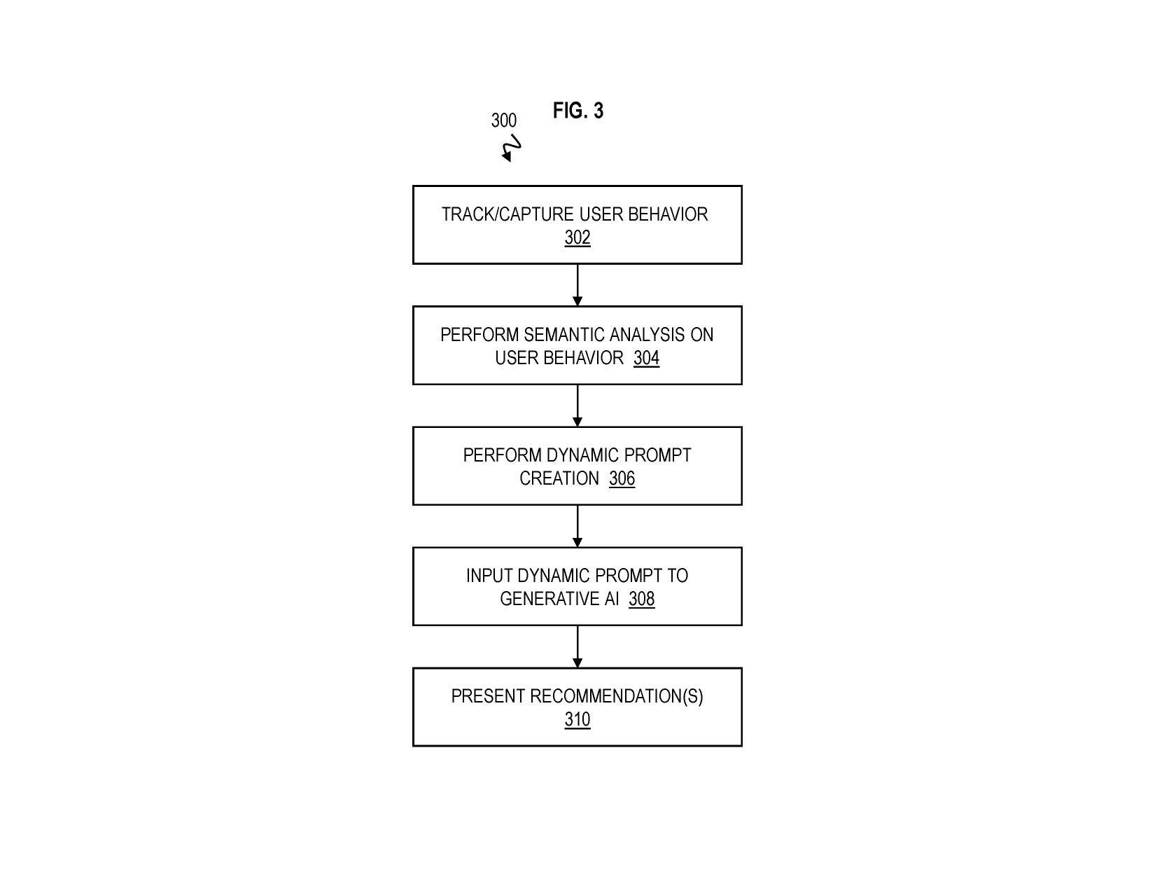

As will be seen below, FIG. 3 illustrates a novel approach by uniquely combining real-time user behavior with knowledge graph insights to dynamically generate AI prompts, distinguishing it from existing technologies. As technical solutions and effects, aspects of embodiments improve user engagement and personalization across multiple domains based on user behavior and improve computing technology by predicting a user’s intention in advance of a user request.

Turning to FIG. 3, a flowchart depicts a computer-implemented method 300 for dynamically (in real-time or near real-time) providing event-driven dynamic prompt creation for enhanced generative AI interactions and presenting AI-generated responses to the user according to one or more embodiments. The computer-implemented method 300 is an overview and can be executed by the computer system 202 on behalf of and in conjunction with the computer systems 220. Reference can be made to any figures discussed herein.

At block 302 of the computer-implemented method 300, the user software 222 of computer system 220 is configured to track and capture user behavior of a user utilizing one or more user devices, such as the computer system 220. The computer system 220 can be representative of multiple user devices that the user utilizes for various activities. In one or more embodiments, the user software 222 may be operating on each of the user devices and/or in communication with the user devices. In one or more embodiments, the user software 222 of computer system 220 can communicate with other user devices to track and capture the user behavior of the user. The user data of the captured user behavior can be stored in user data repositories 280A and 280B. The repository 280B can be stored on computer system 220 and the repository 280A on computer system 202. In one or more embodiments, the user data may be temporarily stored in repository 280B on computer system 220 and then transferred to repository 280A of computer system 202. The user software 222 of computer system 220 can continuously and securely transfer (i.e., push) user data to software 204 of computer system 202, which is then stored in the repository 280A and optionally deleted from the repository 280B. The repositories 280A and 280B can generally be referred to as repository 280.

The user behavior is captured in real-time on computer system 220. Examples of user behavior include capturing real-time user data such as clicks, views, searches, etc., which are analyzed to understand user preferences and immediate needs of the operating the user device. This analysis is used to dynamically influence subsequent AI-generated prompts. It should be appreciated that there are many known techniques for capturing user behavior on a user device, and any such techniques may be utilized by the user software 222. In one or more embodiments, the user software 222 can be downloaded from a website offered by the computer system 202, downloaded from an application store, pre-installed on the user device, and the like.

At block 304, the software 204 of computer system 202 is configured to perform semantic analysis on and/or cause semantic analysis to be performed on the user data of the repository 280A. The software 204 may include and/or call one or more known semantic analysis tools. The software 204 may call an NLP model 262 to perform semantic analysis on the user data of repository 280A, in order for the NLP model 262 to output semantic relationships of the user data. The software 204 may represent the user data with semantic relationships in any standard form including a resource description framework (RDF), web ontology language (OWL), Neo4j, etc., which can be utilized for generating a knowledge graph 270 of user behavior. The knowledge graph 270 contains the entities and relationships of the user data of the repository 280A. The knowledge graph 270 has nodes and relationships that represent the user data. As more user behavior of the user is continuously captured by the computer system 220 and then transferred to the computer system 202, the knowledge graph 270 increases in size to provide a greater picture of the user’s intent in real-time.

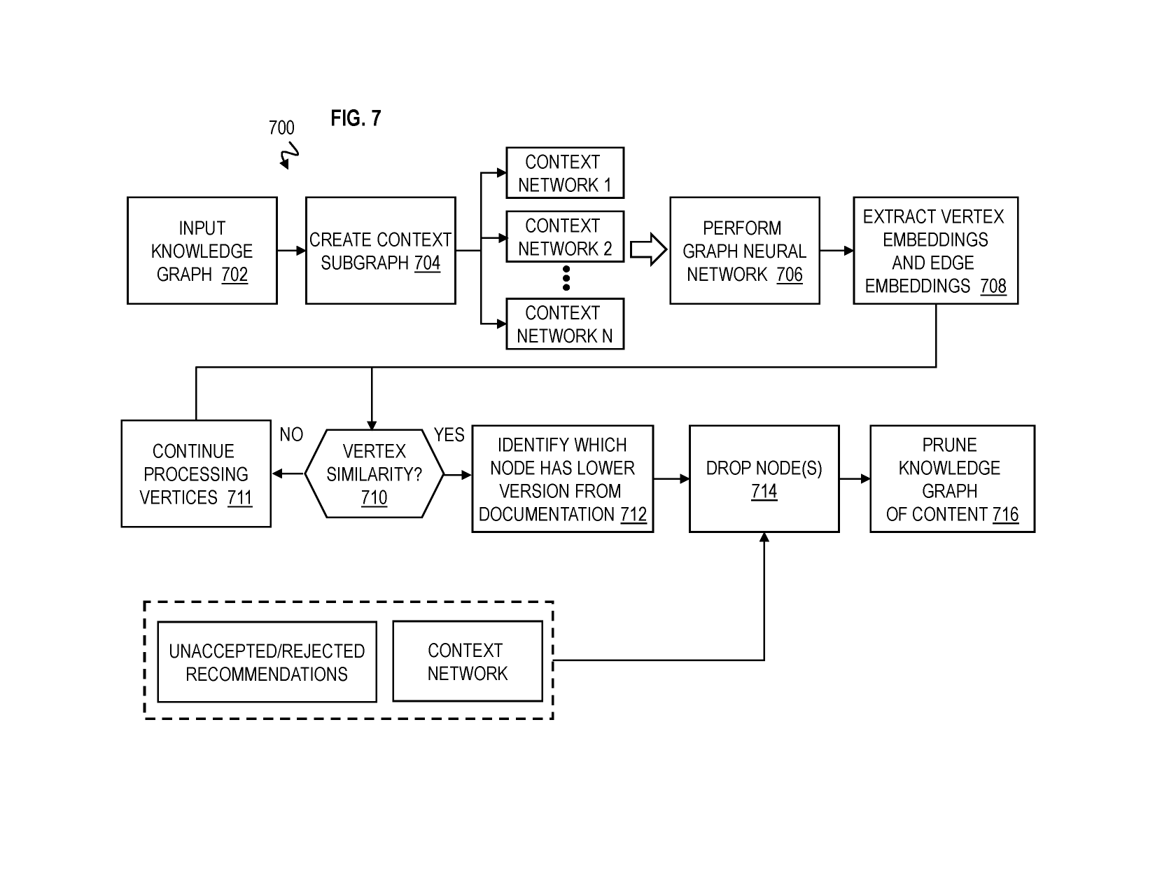

At block 306, the software 204 of computer system 202 is configured to initiate creation and/or cause the creation of one or more dynamic prompts on behalf of the user based on the captured user behavior. The software 204 causes a dynamic prompt 269 to be created using a portion of the knowledge graph 270 of the user. For example, based on real-time (or near real-time) user activity as user behavior received by the software 204 from the computer system 220, the software 204 is configured to analyze the context of the user activity, for example, using NLP and determine a context network 272. The context network 272 is a subgraph in the knowledge graph 270 related to the context of the user activity. The real-time (or near real-time) user activity and the context network 272 are utilized to generate the dynamic prompt 269. Further regarding generative the context network 272 is discussed in FIG. 7.

In one or more embodiments, the software 204 can be integrated with and/or call a prompt generator 268 to create the dynamic prompt 269. An AI prompt generator is a tool that uses advanced NLP and machine learning algorithms to create prompts for generative AI models, and these prompts serve as instructions or starting points to guide the generative AI model (e.g., the generative AI model 242) in generating text, images, or other content. The software 204 inputs the real-time (or near real-time) user activity and the context network 272 to the prompt generator 268 in order to generate the dynamic prompt 269. The software 204 can cause one or more dynamic prompts 269 to be created in accordance with user activities occurring on one or more user devices, where the computer system 220 transmits the user activities to the software 204.

At block 308, the software 204 of computer system 202 is configured to input the dynamic prompt(s) 269 to one or more generative AI models 242 on one or more computer systems 240. The generative AI model 242 processes the input of the dynamic prompt 269 and outputs a corresponding response to the computer system 202.

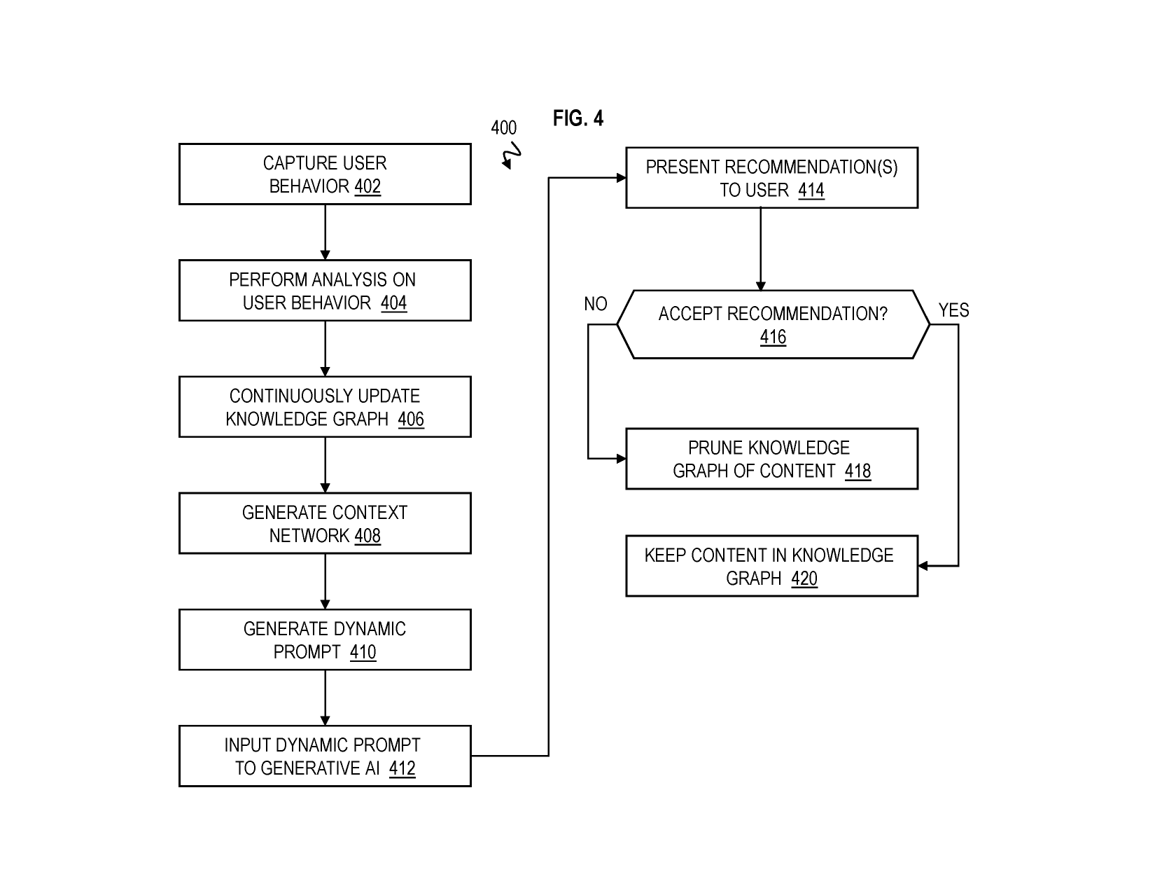

At block 310, in response to receiving the response for each dynamic prompt 269 processed by the generative AI model 242, the software 204 of computer system 202 is configured to present the response to the user of computer system 220 as a recommendation. In one or more embodiments, the software 204 may cause many responses (as recommendations) to be rendered for display on the computer system 220 for selection by the user (e.g., as discussed further in FIG. 4), when many dynamic prompts 269 have been currently generated and processed by generative AI models 242. The responses can be graphically displayed, played as audio, rendered as holograms, etc., on the computer system 220. The software 204 can transfer the responses to the user software 222 for presentation to the user on any connected user devices.

FIG. 4 depicts a flowchart of a computer-implemented method 400 for dynamically (in real-time or near real-time) providing event-driven dynamic prompt creation for enhanced generative AI interactions and presenting AI-generated responses to the user according to one or more embodiments. As a high-level view, the computer-implemented method 400 dynamically generates prompts for generative AI models based on user behavior and events captured in the knowledge graph 270, and the computer-implemented method 400 continuously updates and personalizes prompts according to real-time user interactions and the evolving relationships within the knowledge graph 270. Reference can be made to any figures discussed herein.

At block 402, the user software 222 of computer system 220 is configured to track and capture user behavior of a user utilizing one or more user devices. The user data of the captured user behavior can be stored in user data repositories 280A and 280B. At block 404, the software 204 of computer system 202 is configured to perform semantic analysis on and/or cause semantic analysis to be performed on the captured user data. The software 204 may employ one or more known semantic analysis tools including the NLP model 262 to perform semantic analysis on the user data. At block 406, the software 204 of computer system 202 is configured to generate and continuously update the knowledge graph 270 for the user of computer system 220. Although discussion is related to the knowledge graph 270 related to the user of computer system 220, it should be appreciated that other users have their own (individual) knowledge graphs 270 that reflect their individual user behavior.

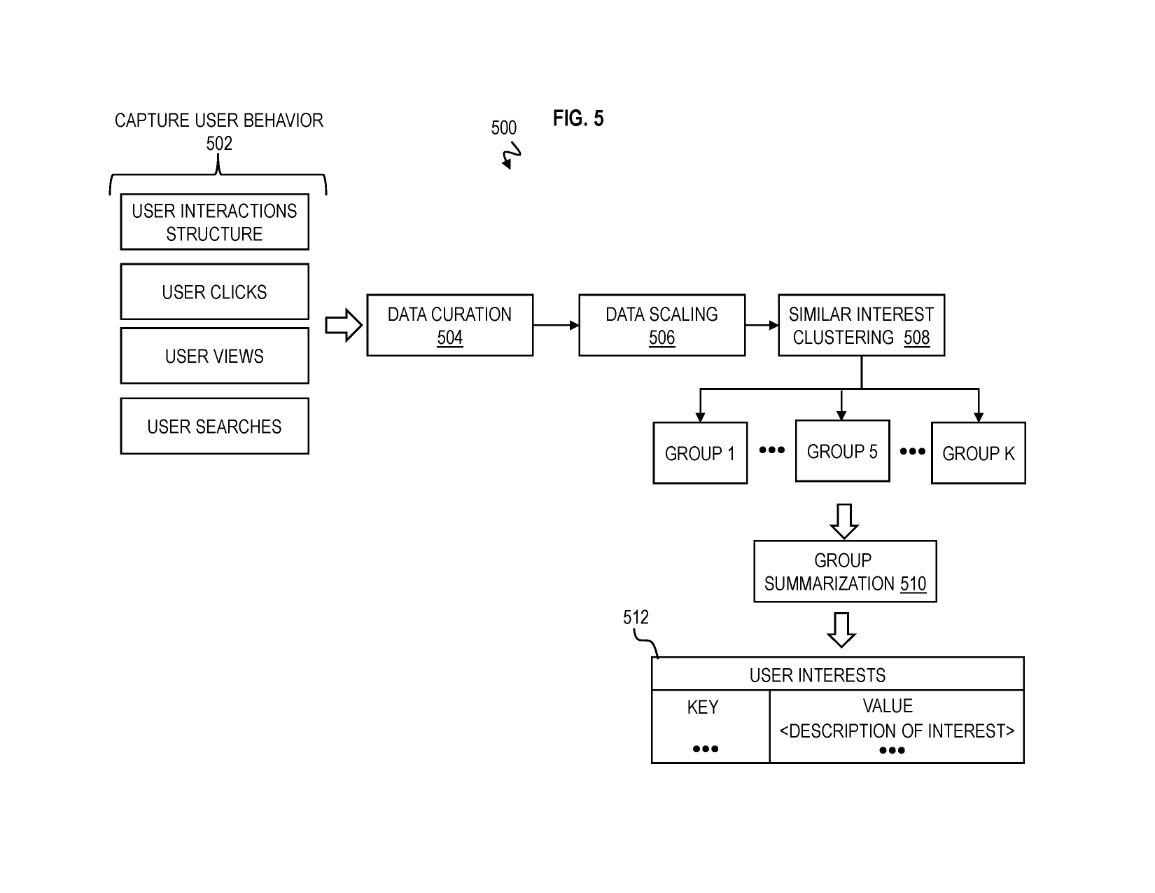

The captured user behavior of the user of computer system 220 is processed to initially form the knowledge graph 270 and then continuously update the knowledge graph 270 as new data of the user behavior is continuously received by the computer system 202. The entities and relationships are extracted from the user behavior and added to the knowledge graph 270. Further details of processing the user behavior of the user are discussed in FIG. 5.

FIG. 5 depicts a flowchart of a computer-implemented method 500 storing and processing user behavior of a user according to one or more embodiments. As discussed herein, the user software 222 and/or any known software captures the user behavior of and/or associated with the computer system 220 at block 502. The user behavior can include user views, user clicks/selections, user searches, etc., on and/or be associated with an electronic device such as the computer system 220. The user behavior is formatted in a user interactions structure. The user interactions structure refers to the organized collection of user actions such as clicks, views, searches, and other activities performed by the user on the user device. These user actions are captured and processed to build a representation of the user’s interests and preferences, which are then clustered and stored. For the captured user behavior, the software 204 also performs preprocessing and/or causes preprocessing to be performed including data curation at block 504, which includes collecting and storing different sources of the user data, and data scrolling at block 506, which includes standardizing the user data because the user data may be in different dimensions. At block 508, the software 204 can cause similar interest clustering to be performed on the user data of the user behavior. For example, the software 204 may employ the clustering algorithm 266 to segregate different areas of interest into different clusters/groups. For example, one cluster/group might be relevant to one topic based on the user clicks, views, searches, etc., while another group may be relevant to another topic based on the user clicks, views, searches, etc. For explanation, there could be clusters/groups 1-K. Each group/cluster can be input to an LLM 274 for group summarization. The LLM 274 is designed and requested to generate detailed information about the user history on the specific topic of the input cluster/group such as groups 1, 2, 3, … K. The software 204 receives a group summarization 510 for each of the input clusters/groups.

As a data structure 512, the software 204 can store this group summarization 510 of the user interests with a key and value in computer system 202, where the key is the user interest (like an index) and the corresponding value for the key is the description of the user interest; the key and value can be utilized to generate the dynamic prompt 269 when the user asks or inquires about the topic of the user interest and/or description. The data structure 512 of numerous key and values can be used to build the knowledge graph 270. Although the data structure 512 only shows a single key and its value for illustration purposes, it should be appreciated that there are numerous keys and corresponding values, thereby making the knowledge graph 270 very large. Each key (i.e., user interest) and its value (i.e., description) can be captured in the knowledge graph 270 of the user as an entity (node) and edge relationship. The knowledge graph 270 can have many entities (nodes) that are related to the same and/or similar topics of the user.

Returning to FIG. 4, at block 408, the software 204 of computer system 202 is configured to generate the context network 272 specific to user activity (e.g., real-time or near real-time user activity. As determined by the software 204, for example, using NLP, the user activity is related to and/or has the same or similar topic/context of entities (nodes) and edges in the knowledge graph 270 (i.e., keys and values of the data structure 512). The software 204 can parse or query the knowledge graph 270 for the user activity (i.e., the same or similar topic/context) and extract the related subgraph of the knowledge graph 270 as the context network 272. The context network 272 is generated by extracting a relevant subgraph from the knowledge graph 270 based on the real-time or near real-time user activity. This activity is analyzed using Natural Language Processing (NLP) techniques to identify related entities and topics from the knowledge graph 270 that match the user’s current interactions. As part of the personalization, the extracted context network 272, which includes nodes and edges, is specific to the topic/context of the user activity just performed or currently being performed by the user on the computer system 220.

At blocks 410, 412, and 414, the software 204 of computer system 202 is configured to initiate creation and/or cause the creation of one or more dynamic prompts 269 on behalf of the user based on user behavior, input the dynamic prompt(s) 269 to one or more generative AI models 242, and present the response to the user of computer system 220, as discussed herein. The response can be presented as a recommendation to the user of the computer system 220, which the user can accept or reject. The computer system 220 is configured to continuously learn in real-time from the user behavior as well as the acceptance and rejection of recommendations. The knowledge graph 270 is enlarged based on continuous user behavior on user devices, and nodes of the knowledge graph 270 (representing context networks) are removed in response to rejections of recommendations. The repeated user behavior provides continuous learning (reinforced learning) for the computer system 202 to create relevant and personalized dynamic prompts for the user, thereby delivering accurate and timely recommendations.

At block 416, the software 204 of computer system 202 is configured to check whether the user accepted or rejected the recommendation (i.e., the generated response output from the generative AI model 242 after receiving the dynamic prompt 269). In one or more embodiments, there can be selectable objects for accepting or rejecting a recommendation. Additionally, user interaction with the recommendation, such as scrolling, viewing, copying, etc., the recommendation as well as time with the recommendation prominently displayed, can be interpreted as accepting the recommendation. On the other hand, the lack of user interaction, such as quickly dismissing the recommendation or ignoring the recommendation, can be interpreted as rejecting the recommendation.

At block 418, when the user rejects the recommendation, the software 204 of computer system 202 is configured to prune the knowledge graph 270 of the context network 272 used to generate the dynamic prompt 269 that was input to the generative AI model 242 for outputting the response that is rejected. Further details regarding pruning the knowledge graph 270 is discussed in FIG. 7. At block 420, when the user accepts the recommendation, the software 204 of computer system 202 is configured to keep the context network 272 as part of the knowledge graph 270.

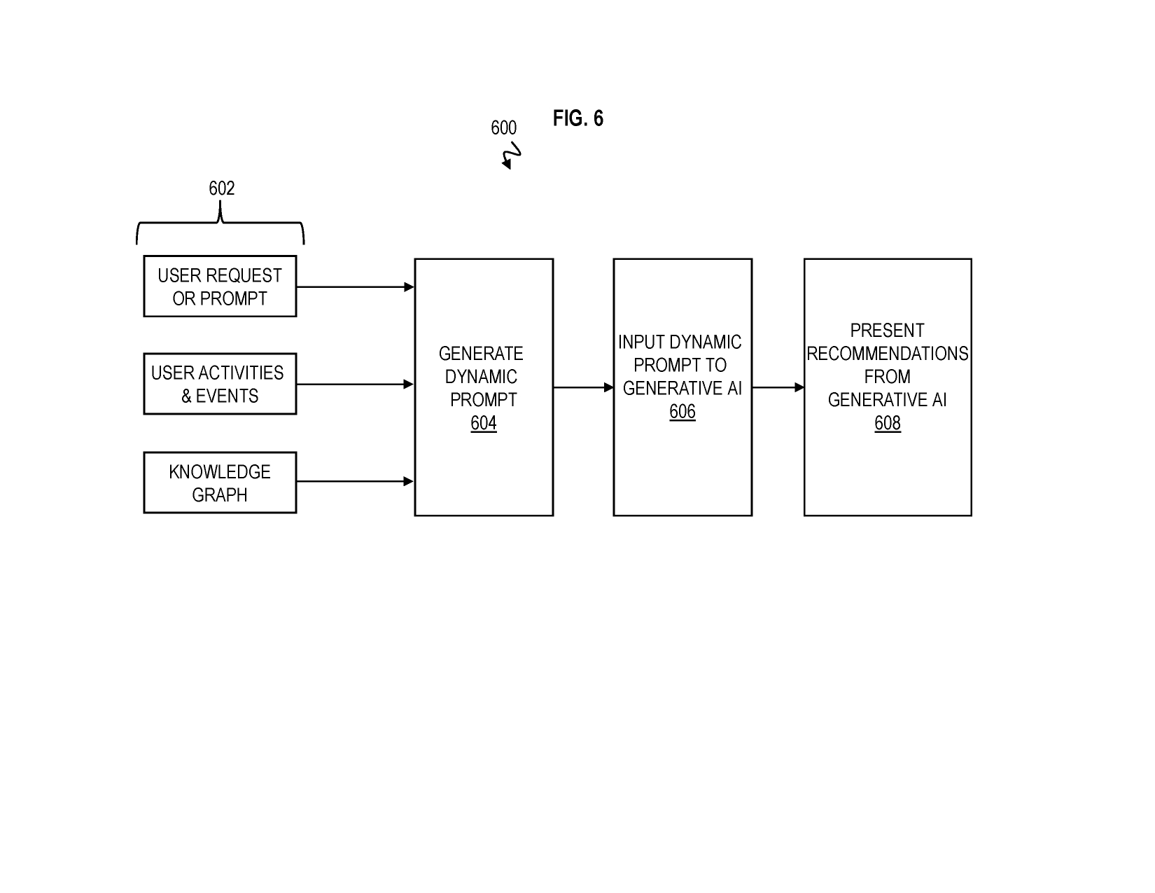

FIG. 6 depicts a flowchart of a computer-implemented method 600 for dynamic prompt creation for response generation and presentation to the user according to one or more embodiments. At block 602, the software 204 of computer system 202 is configured to receive a trigger and/or determine that a trigger is received for creation of a dynamic prompt for the user. The trigger could be an optional user request from the user, an optional user prompt intended for a generative AI model that is intercepted by the computer system 202, a user login, user activities and events, information in the knowledge graph 270, etc. At block 604, based on the user request from the user, the intercepted user prompt intended for the generative AI model, user login, user activities and events on the computer system 220, information in the knowledge graph 270, etc., the software 204 of computer system 202 is configured to create and/or cause the creation of one or more dynamic prompts 269 on behalf of the user in accordance with the user behavior. The software 204 can employ the prompt generator 268 to create the dynamic prompt 269. For example, the software 204 can instruct the prompt generator 268, an LLM, etc., to generate a prompt based on the intercepted user prompt intended for the generative AI model, user data (of repository 280) of current user activities and events, and a corresponding context network 272 in the knowledge graph 270 where the context network 272 is the same topic as the intercepted user prompt and/or the user data 280 of current user activities and events. At blocks 606 and 608, the software 204 of computer system 202 is configured to input the dynamic prompt 269 to one or more generative AI models 242, receive the response(s), and present the response(s) as a recommendation(s) to the user of computer system 220.

FIG. 7 depicts a flowchart of a computer-implemented method 700 for knowledge graph pruning according to one or more embodiments. At blocks 702 and 704, the software 204 is configured to input the knowledge graph and create context subgraphs as context network 1, context network 2, through context network N. The context networks are specific to topics, which may be determined by topic modelling. At blocks 706 and 708, the software 204 is configured input the context networks 1-N into graph neural networks 264 that extract vertex (node) embeddings and edge embeddings from each of the respective context networks 1-N. A graph neural network (GNN) belongs to a class of artificial neural networks for processing data that can be represented as graphs (i.e., graph data structures). The input graph is passed through a series of neural networks. The input graph structure is converted into graph embeddings (including the vertex (node) embeddings and edge embeddings from the respective context networks 1-N), allowing one to maintain information on nodes and edges (e.g., in a global context). Then, the feature vector of nodes is passed through the neural network layer, and it aggregates these features and passes them to the next layer.

At block 710, the software 204 is configured to determine the similarity between given vertices (nodes), for example, by comparing their vertex embeddings. The software 204 may call similarity algorithms or clustering algorithms 266 to determine the degree of similarity between vertices. The software 204 can cause numerous vertices to compared at once. If there is no similarity and/or if the similarity is below a predefined threshold between any two vertices (nodes), additional vertices are compared until all vertices have been compared to each other at block 711. At block 712, when there is a vertex similarity found between two vertices (nodes), the software 204 is configured to identify which vertex/node has a lower version, for example, from documentation. The documentation refers to additional metadata or external sources of information that the system can use to determine whether a vertex (node) in the knowledge graph 270 represents outdated or less informative content compared to another vertex. In one or more embodiments, for the similar vertices/nodes, the software 204 has information or documentation that one vertex/node is related to older information, outdated information, and/or an older version than another vertex/node. Also, the software 204 can scan/search the Internet including various websites, publications, generative AI models, etc., to determine that one vertex/node is a lower (older) version of another vertex/node. The lower version could relate to the node that is less informative or less descriptive.

At block 714, for the similar vertices/nodes, the software 204 is configured to drop or remove the vertex/node determined to have the lower version (i.e., the more outdated vertex/node). For a particular dynamic prompt generated from a context network, the vertices/nodes can also be dropped/removed from the knowledge graph 270 when recommendations (i.e., responses) are unaccepted/rejected for the context network utilized to generate that dynamic prompt.

At block 716, the software 204 is configured to prune/remove the content, which is the vertex/node determined to have the lower version (i.e., the more outdated vertex/node), from the knowledge graph 270. The vertex/node determined to be dropped/removed can correspond to one of the context networks, for example, such as context network 1, and the corresponding context network 1 having one or more nodes and edges is removed from the knowledge graph 270. Accordingly, the software 204 does not utilize the vertices/nodes (i.e., context networks) that have been dropped/pruned from the knowledge graph 270 when generating subsequent dynamic prompts.

For explanation purposes and not limitation, an example scenario is being provided below. In this example scenario, Bob is a software developer that is looking for computer tools to optimize his workflow. Bob may be utilizing a user device, such as the computer system 220, to search for and read about computer tools on the Internet including websites, digital publications, social media sites, etc. Bob spends a lot of time exploring different code editors and version control systems. Bob reads electronic articles about the latest trends in DevOps (development and operations) and shows some interest in cloud development environments. This is all user behavior for Bob, which is collected and stored as user data in the repository 280 (e.g., block 302 in FIG. 3).

For user behavior analysis based on the user data of repository 280, the software 204 analyzes the user actions of Bob on the platform to gather insights into his preferences and needs. Bob has clicked on several listings for code editors and version control systems, viewed detailed pages and specifications for these tools, spent time reading reviews and comparisons between different tools, and searched for integration capabilities with other development tools, indicating a preference for interoperability. This user behavior analysis shows that Bob has an interest in computer tools that enhance coding efficiency and team collaboration. Further, the software 204 determines that Bob has an interest in learning, because Bob reads multiple articles on DevOps and cloud development, indicating a desire to integrate more advanced development practices (e.g., block 304 in FIG. 3).

For semantic analysis using knowledge graph insights into the knowledge graph 270 of the user data, the software 204 examines the relationships between the products Bob has interacted with and other related services or tools (e.g., block 306 in FIG. 3). By parsing the knowledge graph 270, the software 204 determines that code editors and version control systems are linked in the knowledge graph 270 with Continuous Integration/Continuous Deployment (CI/CD) tools, suggesting a common workflow enhancement. Bob’s interest in integration capabilities is supported by connections (edges) in the knowledge graph 270 to DevOps tools that facilitate seamless development environments. The knowledge graph 270 also highlights trending technologies like cloud development environments which are growing in popularity among developers looking for scalable solutions. This semantic analysis identifies that, while Bob is directly interested in certain tools, he could benefit from additional resources that support a comprehensive, integrated development environment. As complementary products, the software 204 determines there is a strong link between version control systems, code editors, and CI/CD tools in the knowledge graph 270.

For dynamic prompt creation for Bob based on the user behavior analysis and the knowledge graph insights, the software 204 generates a dynamic prompt crafted based on both Bob’s explicit interactions and the semantic insights gathered from the knowledge graph 270 (e.g., block 306 in FIG. 3). In an example, the software 204 may create the following dynamic prompt 269 for Bob: “Recommend a suite of development tools for a software developer interested in code editors, version control systems, and enhanced integration capabilities, emphasizing ease of setup and interoperability for team projects.” This dynamic prompt 269 integrates Bob’s demonstrated preferences with additional, relevant options inferred from the knowledge graph 270.

The dynamic prompt 269 is input to the generative AI model 242 in order to obtain a response that is presented to Bob as a recommendation (e.g., block 308).

As the generative AI recommendation using the tailored prompt, the AI generates personalized recommendations (e.g., at block 310 in FIG. 3). The generative AI model 242 may output/suggest a popular CI/CD platform known for its excellent integration with the most-used code editors and version control systems that Bob viewed. The recommendation includes details on how this CI/CD tool can streamline Bob’s workflow, highlighting features like automated builds, testing, and deployment, which enhance productivity and collaboration. The generative AI model 242 may also output a webinar or tutorial that shows how to integrate these tools into an existing development setup, adding educational value to the recommendation. The suggestions of the generative AI model 242 are designed to be directly applicable to Bob’s current interests while also introducing him to beneficial tools that align with his broader needs, as identified through his behavior and the knowledge graph analysis. This example scenario shows how aspects of embodiments can utilize a dynamic understanding of user behavior and contextual relationships to deliver highly personalized and actionable recommendations.

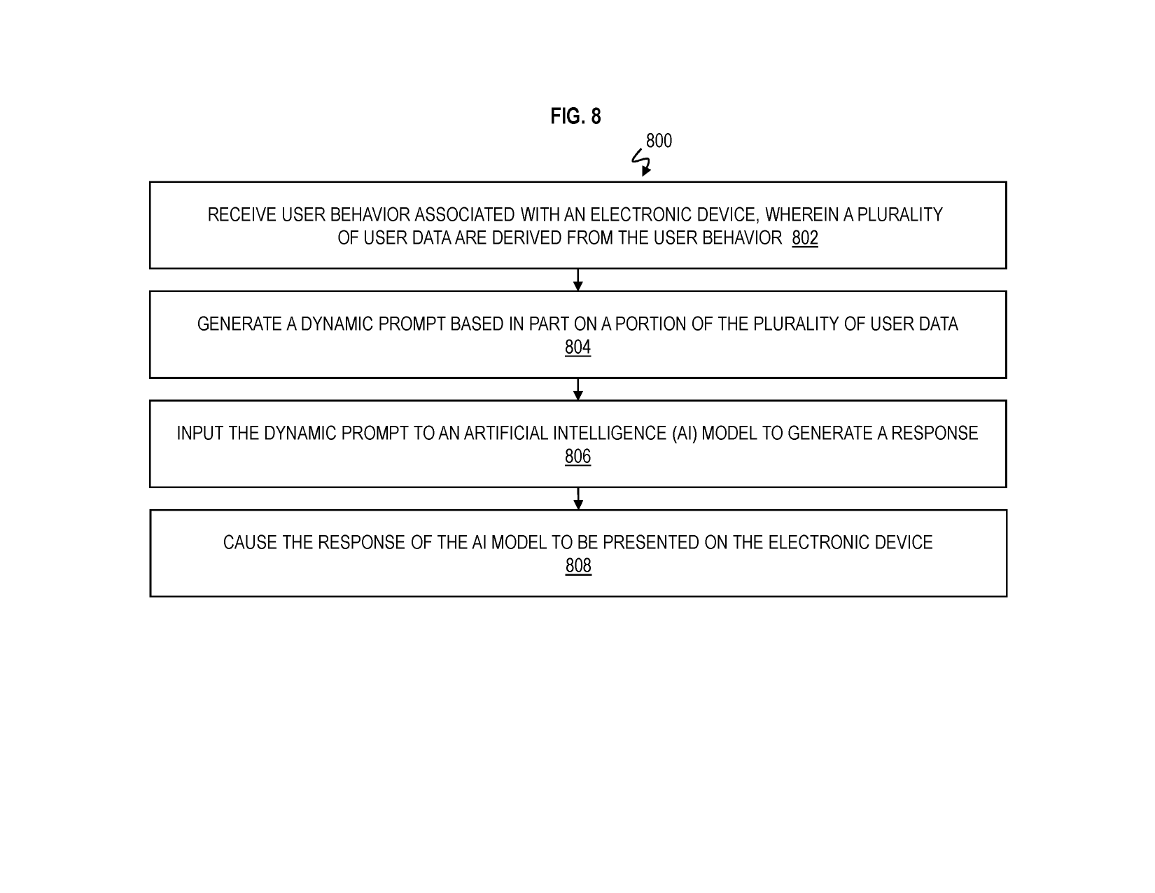

FIG. 8 depicts a flowchart of a computer-implemented method 800 for providing event-driven dynamic prompt creation for enhanced generative AI interactions such that the dynamic prompt is utilized as input to one or more generative AI models on behalf of a user in order to receive responses according to one or more embodiments. Reference can be made to any of the figures discussed herein.

At block 802 of the computer-implemented method 800, the computer system 202 is configured to receiving user behavior associated with an electronic device (e.g., one or more user devices such as the computer system 220), where a plurality of user data are derived from the user behavior. At block 804, the computer system 202 is configured to generate a dynamic prompt 269 based in part on a portion of the plurality of user data (e.g., in repository 280). At block 806, the computer system 202 is configured to input the dynamic prompt 269 to an artificial intelligence (AI) model (e.g., generative AI model 242) to generate a response. At block 808, the computer system 202 is configured cause the response of the AI model to be presented on the electronic device. The software 204 can transmit the response(s) to the user software 222 of the computer system 220 for graphical presentation, audio presentation, video presentation, holographic presentation, etc., to the user.

Further, the computer system 202 is configured to generate a knowledge graph 270 of the plurality of user data of the user behavior. A knowledge graph 270 of the plurality of user data of the user behavior is enlarged in accordance with further capturing the user behavior. The computer system 202 is configured to, in response to causing the response of the AI model to be presented on the electronic device (e.g., computer system 220), receive a user selection (e.g., acceptance or rejection), where a knowledge graph 270 includes the plurality of user data, and prune the knowledge graph 270 by removing the portion of the plurality of user data from the knowledge graph 270, in response to receiving the user selection (e.g., rejection).

A context network (e.g., context network 272) is generated from the portion of the plurality of user data in the knowledge graph 270. The generating the dynamic prompt based in part on the portion of the plurality of user data includes: detecting an action as the user behavior in real-time, predicting an intention of the user based on the action detected in real-time, determining that the intention is related to the portion in a knowledge graph 270 of the plurality of data, and triggering generation of the dynamic prompt in response to the action captured in real-time, such that the dynamic prompt corresponds to both the action and the portion in the knowledge graph 270. The dynamic prompt 269 is generated and input to the AI model (e.g., generative AI model 242) prior to a user request.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

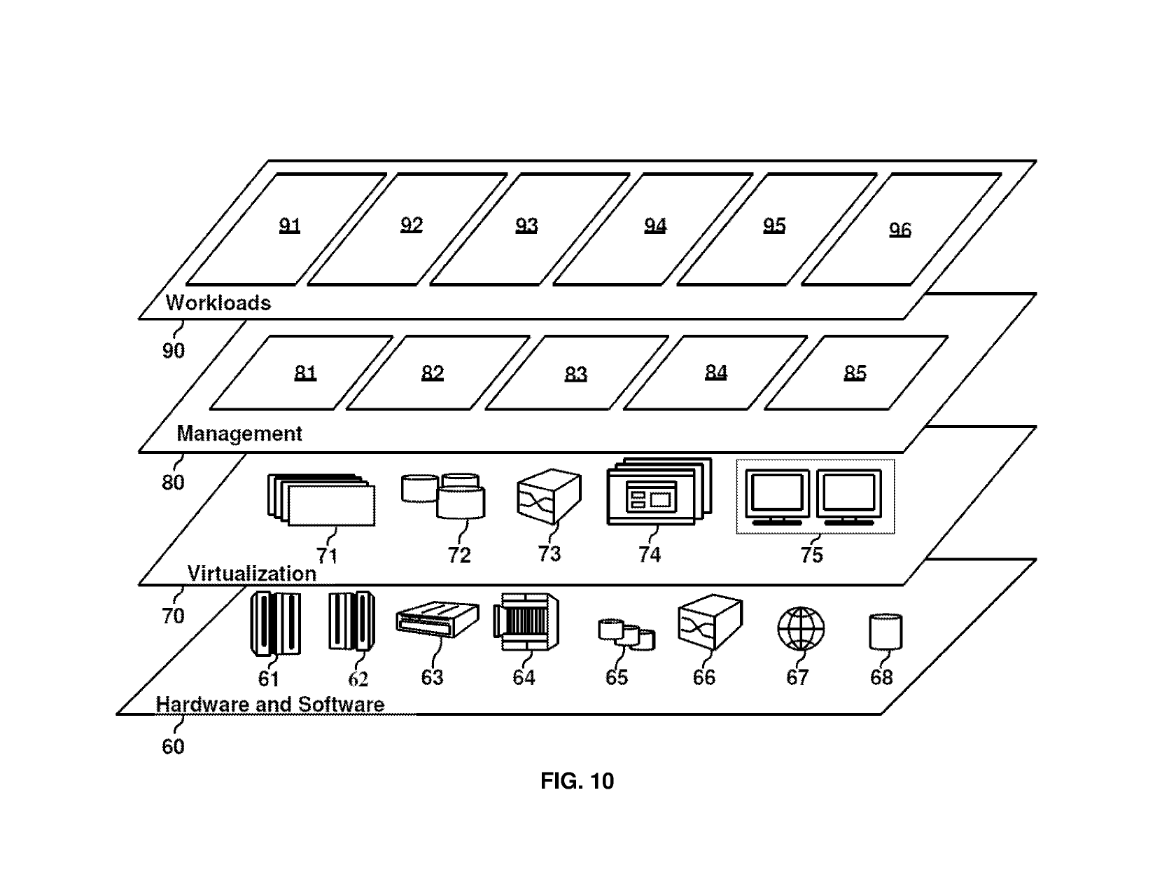

Referring now to FIG. 10, a set of functional abstraction layers provided by cloud computing environment 50 (depicted in FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. One or more aspects of embodiments may be executed, at least in part, by workloads and functions 96. In one or more embodiments, the software 204, the NLP model 262, the graph neural networks 264, clustering algorithms 266, the prompt generator 268, the knowledge graph 270, context network 272, the generative AI models 242, repositories 280, etc., can utilize, be executed as, and/or be integrated with workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions may execute entirely on the user’s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a plurality of user data characterizing user behavior associated with an electronic device;
generating a dynamic prompt based in part on a portion of the plurality of user data;
inputting the dynamic prompt to an artificial intelligence (AI) model to generate a response; and
causing the response of the AI model to be presented on the electronic device.

2. The computer-implemented method of claim 1, further comprising generating a knowledge graph of the plurality of user data.

3. The computer-implemented method of claim 1, wherein a knowledge graph of the plurality of user data is enlarged in relation to capturing the user behavior.

4. The computer-implemented method of claim 1, further comprising, in response to causing the response of the AI model to be presented on the electronic device, receiving a user selection, wherein a knowledge graph comprises the plurality of user data; and
pruning the knowledge graph by removing the portion of the plurality of user data from the knowledge graph, in response to receiving the user selection.

5. The computer-implemented method of claim 1, wherein a context network is generated from the portion of the plurality of user data in a knowledge graph.

6. The computer-implemented method of claim 1, wherein the generating the dynamic prompt based in part on the portion of the plurality of user data comprises:
detecting an action as the user behavior in real-time;
predicting an intention based on the action detected in real-time;
determining that the intention is related to the portion in a knowledge graph of the plurality of user data; and
triggering generation of the dynamic prompt in response to the action captured in real-time, such that the dynamic prompt corresponds to both the action and the portion in the knowledge graph.

7. The computer-implemented method of claim 1, wherein the dynamic prompt is generated and input to the AI model prior to a user request.

8. A system comprising:
a memory having computer readable instructions; and
one or more processors for executing the computer readable instructions, the computer readable instructions when executed cause the one or more processors to perform operations comprising:
receiving a plurality of user data characterizing user behavior associated with an electronic device;
generating a dynamic prompt based in part on a portion of the plurality of user data;
inputting the dynamic prompt to an artificial intelligence (AI) model to generate a response; and
causing the response of the AI model to be presented on the electronic device.

9. The system of claim 8, wherein the one or more processors perform the operations further comprising generating a knowledge graph of the plurality of user data.

10. The system of claim 8, wherein a knowledge graph of the plurality of user data is enlarged in relation to capturing the user behavior.

11. The system of claim 8, wherein the one or more processors perform the operations further comprising, in response to causing the response of the AI model to be presented on the electronic device, receiving a user selection, wherein a knowledge graph comprises the plurality of user data; and
pruning the knowledge graph by removing the portion of the plurality of user data from the knowledge graph, in response to receiving the user selection.

12. The system of claim 8, wherein a context network is generated from the portion of the plurality of user data in a knowledge graph.

13. The system of claim 8, wherein the generating the dynamic prompt based in part on the portion of the plurality of user data comprises:
detecting an action as the user behavior in real-time;
predicting an intention based on the action detected in real-time;
determining that the intention is related to the portion in a knowledge graph of the plurality of user data; and
triggering generation of the dynamic prompt in response to the action captured in real-time, such that the dynamic prompt corresponds to both the action and the portion in the knowledge graph.

14. The system of claim 8, wherein the dynamic prompt is generated and input to the AI model prior to a user request.

15. A computer program product comprising a computer readable storage medium having program instructions embodied therewith, the program instructions executable by one or more processors to cause the one or more processors to perform operations comprising:
receiving a plurality of user data characterizing user behavior associated with an electronic device;
generating a dynamic prompt based in part on a portion of the plurality of user data;
inputting the dynamic prompt to an artificial intelligence (AI) model to generate a response; and
causing the response of the AI model to be presented on the electronic device.

16. The computer program product of claim 15, further comprising generating a knowledge graph of the plurality of user data.

17. The computer program product of claim 15, wherein a knowledge graph of the plurality of user data is enlarged in relation to capturing the user behavior.

18. The computer program product of claim 15, further comprising, in response to causing the response of the AI model to be presented on the electronic device, receiving a user selection, wherein a knowledge graph comprises the plurality of user data; and
pruning the knowledge graph by removing the portion of the plurality of user data from the knowledge graph, in response to receiving the user selection.

19. The computer program product of claim 15, wherein a context network is generated from the portion of the plurality of user data in a knowledge graph.

20. The computer program product of claim 15, wherein the generating the dynamic prompt based in part on the portion of the plurality of user data comprises:
detecting an action as the user behavior in real-time;
predicting an intention based on the action detected in real-time;
determining that the intention is related to the portion in a knowledge graph of the plurality of user data; and
triggering generation of the dynamic prompt in response to the action captured in real-time, such that the dynamic prompt corresponds to both the action and the portion in the knowledge graph.
